(19) United States
(12) Patent Application Publication
(10) Pub. No.: US 2018/0099468 A1
(43) Pub. Date: Apr. 12, 2018

(54) PELLET MILL CONTROLLER

(71) Applicants: Christopher M. Gaalswyk, Trimont, MN (US); John Clymer, Northrop, MN (US)

(72) Inventors: Christopher M. Gaalswyk, Trimont, MN (US); John Clymer, Northrop, MN (US)

(21) Appl. No.: 15/722,186

(22) Filed: Oct. 2, 2017

Related U.S. Application Data
(60) Provisional application No. 62/406,629, filed on Oct. 11, 2016.

(51) Int. Cl. B30B 11/00

(52) U.S. Cl. CPC B30B 11/006

(57) ABSTRACT

Using advanced control theories, the pellet mill controller of the present invention implements an estimator to monitor the conditioner input variables of steam, material density, feed rates, and estimates the material departure temperature and moisture content while accounting for transit time.

### CROSS REFERENCE TO RELATED APPLICATIONS

This application claims priority from U.S. Provisional patent Application, Ser. No. 62/406,629 filed Oct. 11, 2016, entitled Automated Pellet Mill Controller, which is incorporated herein by reference in its entirety.

### BACKGROUND OF INVENTION

### Field of the Invention

The present invention relates to the field of pellet mills, and more particularly to an automated and efficient control of pellet mills.

### Description of Art

Pellet mills and the process of producing pellet material are well known in the art. Pellet mills are generally known for pelletizing raw materials, foodstuffs, feedstuffs, wood, and biofuels. The pelletizing process results in the transformation of a solid powdery or pasty material into hard pellets or granules which are easier to handle for a consumer that unpelletized materials.

While simple from an overview perspective, pellet mills present unique design challenges. The lengthy transit time across the conditioner, along with the change in material properties make traditional PID controls inadequate for fast responding control of a pellet mill.

### BRIEF SUMMARY OF THE INVENTION

Using advanced control theories, the present invention implements an estimator to monitor the conditioner input variables of steam, material density, feed rates, and estimates the material departure temperature and moisture content while accounting for transit time.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings wherein:

FIG. 1 is a schematic diagram showing the pellet mill components;

FIG. 2 is an overview of a pellet mill manufacturing flow;

FIG. 3 is a state diagram of the supervisory control;

FIG. 4 is a flow diagram illustrating pellet mill flow; and

FIG. 5 is a state diagram of feeder control modes;

FIG. 6 is an integrated flow diagram showing the pellet mill control loops;

FIG. 7 is a flow diagram of the mash control loop;

FIG. 8 is a flow diagram of the thermal loop;

FIG. 9 is a flow diagram of the liquid controller;

FIG. 10 is a flow diagram of the cooler control loop;

FIG. 11 is a schematic diagram illustrating the estimator operation; and

FIG. 12 is a graph comparing linear ramping and curved ramping of the feed rate.

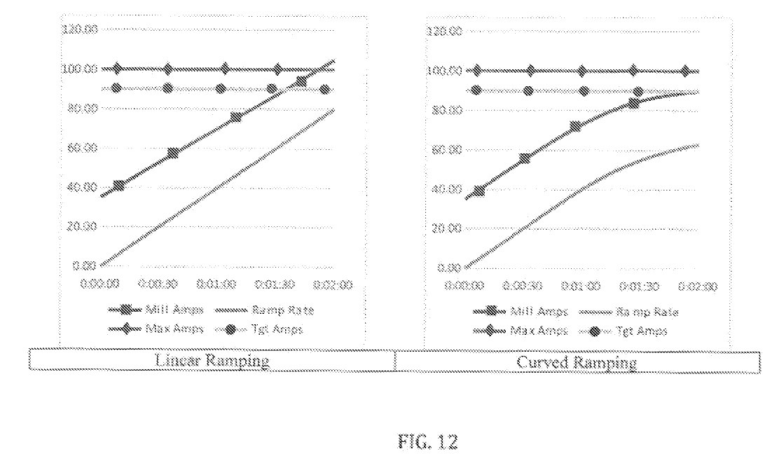

### DETAILED DESCRIPTION OF THE INVENTION

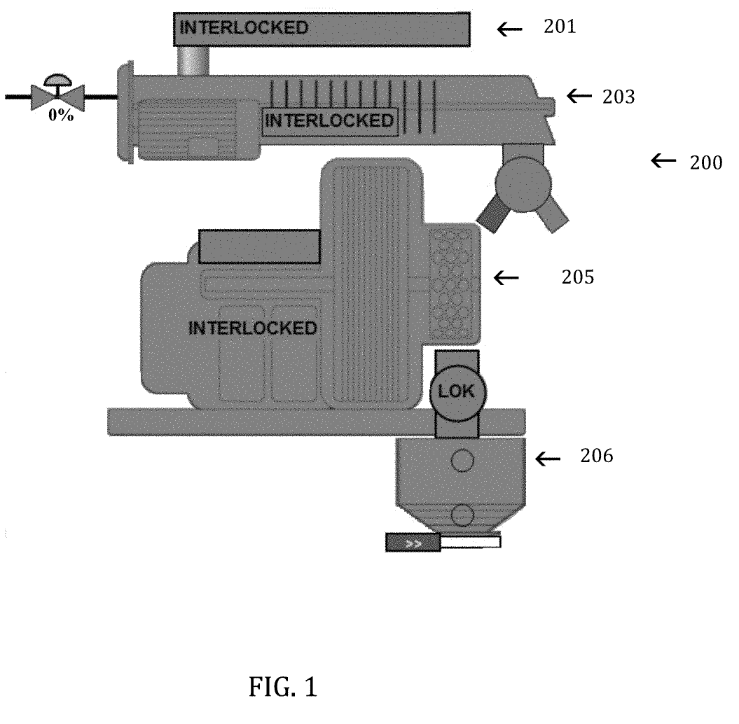

As can be seen by references to the drawings and particularly to FIG. 1, a pellet mill 200 is depicted that includes a feeder 201, a conditioner 203, a pelleter 205, and a cooler 206.

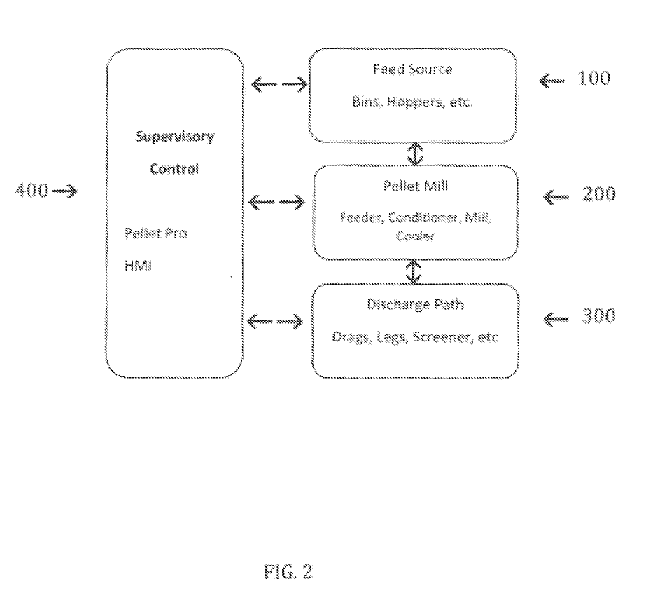

For the purpose of control, the pellet mill manufacturing “flow” is divided into the following groups: feed source 100, pellet mill 200, discharge path 300, and supervisory control 400 as shown in FIG. 2.

The feed source 100 is relatively simplistic, consisting of a source bin with low level indicators, with the ability to have multiple source bins, augers, surge hoppers, etc. Feed source 100 consists of everything up to, but not including, the feeder screw to the pelleter.

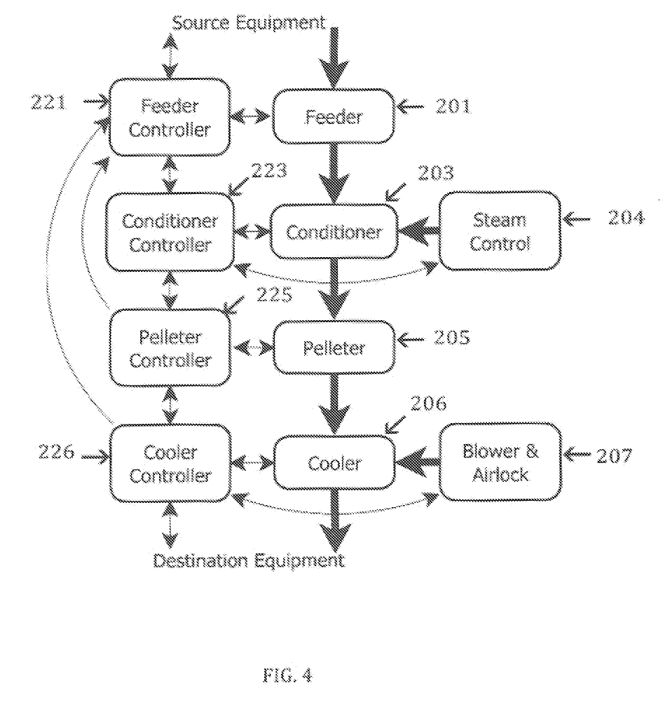

As illustrated in FIG. 4 the pellet mill 200 comprises the primary control loops, includes the screw feeder 201 to the mill 200, the conditioner 203, steam control 204, pelleter 205, cooler 206, and supporting equipment 207. The greatest control challenges are located in the pellet mill block, due primarily to the process delay of product moving through the conditioner 203.

The discharge path 300 entails everything from the cooler to the final pellet destination, this can include coaters, screeners, crimpers, etc.

Supervisory Control 400 provides comprehensive interface between the safety interlocks 401 and automatic control modes 402 for the entire mill.

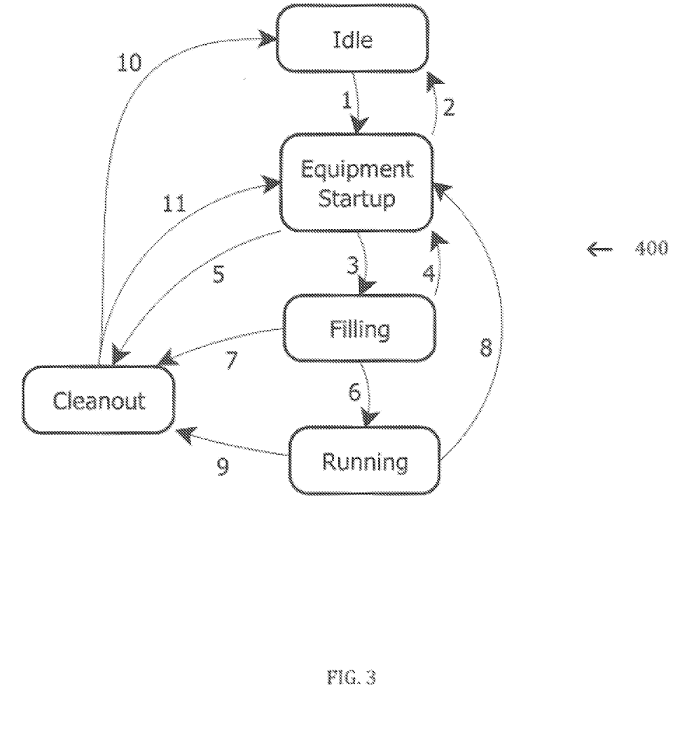

Supervisory control 400 is represented by the state diagram of FIG. 3, and the following Table I:

TABLE 1

| State | Description | Transitions |
|---|---|---|
| Idle/ | Feeders OFF/Manual, | 1—START request, no |
| Manual | Shutdown timers active | errors |
| Equipment | Startup of all equipment up to - | 2—STOP or equipment |
| Startup | BUT NOT - the feeder, | fail, no product ran |
| | from destination to source | 3—All equipment started, |
| | | no holds in place |
| | | 5—STOP or equipment |
| | | fail, some product ran |
| Filling | All equipment running, | 4—HOLD, PAUSE or fill |
| | feeder running at minimum | equipment stoppage |
| | speed, steam control enabled. | 6—All equipment “filled” |
| | | with product |
| | | 7—STOP, CLEANOUT or |
| | | equipment stoppage |
| Running | All equipment running, ramp- | 8—HOLD, PAUSE or fill |
| | up and PID modes enabled | equipment stoppage |
| | | 9—STOP, CLEANOUT or |
| | | equipment stoppage |
| Cleanout | Feeders cleaned out then | 10—Cleanout finished |
| | stopped, all equipment | 11—RESUME request |
| | remains running for their | |
| | perspective auto shutdown | |
| | time | |

The pellet mill entails the heart of the control system, and is where the most complex control algorithms are used. The material flows as illustrated in FIG. 4.

Connected to a VFD, the feeder 201 provides the primary control point for feed entering the system. By monitoring VFD speed, motor current and the source bin low level status, an accurate estimate of the material entering the system can be calculated.

The conditioner 203 provides a continuous, but slow, mixing of feed and steam to increase feed temperature and moisture content. The travel time for feed to go from one end of the mixer to the other end can be as short as 10 seconds to as long as 90 seconds.

The pelleter 205 includes a set of rollers and die to produce pellets by pressing the feed through the holes in the die.

The pellets get passed over a continuous flow of air through the cooler 206 to bring the pellets down to a manageable temperature range for storage and handling.

### Feeder Controller

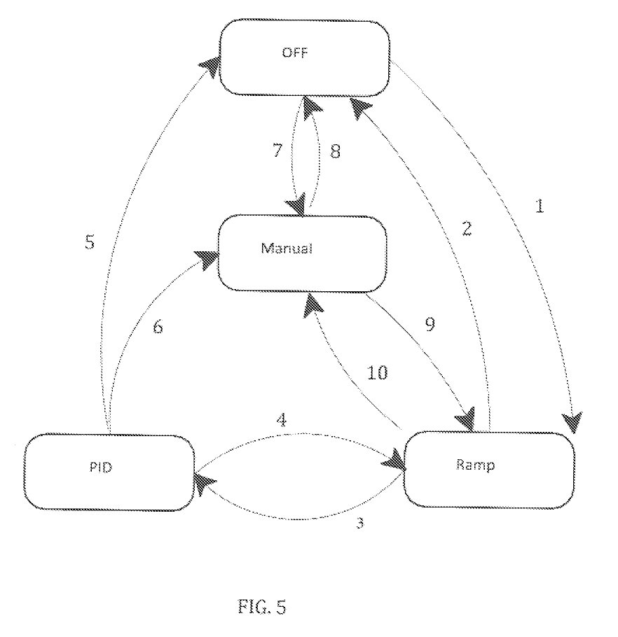

Given target pelleter load (in amps) and pelleter throughout (tons/hours) the feeder controller 221 automatically regulates the feed rate to the pelleting system. Its parameters allow it to accurately calculate throughout in ft³ and pounds. Two modes of automatic operation are included with automatic switchover, as illustrated in FIG. 5.
1) Ramp-up Mode: On switching to automatic, the feeder controller will look at the current rate, if the current rate in <80% of target, it will go into linear ramp-up mode. The start of the ramp will be the higher of the current rate or the minimum rate, end of the ramp-up will be >=80% of target rate.
2) Once out of ramp-up mode, a slower PID mode will be entered. In PID mode, motor amps and/or feed rate are feed to a PID algorithm for small adjustments.

In the event of a HOLD signal, the feeder will be stopped. Upon release of HOLD, ramp-up will again be entered, with the minimum set as starting point. Conditioner, pelleter or cooler NOT running constitutes a HOLD signal, along with user entered HOLD state.

The feeder will only run in the FILLING, RUNNING or CLEANOUT steps (see FIG. 3). Once source is cleaned out, a cleanout timer on the feeder will automatically turn off the feeder in the CLEANOUT step.

In the event of a mill motor over-amp condition, the feeder equipment stops. The system an optionally auto restart equipment after the mill motor amps have dropped below the high threshold.

The feeder motor amps will be monitored along with source bin level inputs to properly detect empty conditions.

To target mill motor amps, the pelleter controller 225 will feed a “Feed Rate/Motor Amps” parameter. This parameter is used for feeder speed target calculations.

RAMP HOLD—the conditioner can signal the feeder to NOT ramp up any further conditioner temperatures are not within acceptable ranges.

The feeder controller actions are summarized in Table II.

### Conditioner Controller

The conditioner controller 223 receives an estimated feed rate from the feeder 201. Given a transit time parameter, the conditioner is broken into several slices represents a section of the conditioner 201.

Each slice period, material is moved through the conditioner slices AND calculations of temperature rise based on steam application rates are performed. At the end of the transit time, the estimated temperature and actual temperature are compared and used to update estimation constants.

Each Slice period, the following steps are preformed:
1) Steam application rate divided equally amongst “slices” and used to calculate heat units this slice has received.
2) Based on received heat units, each slice's current and future temperatures, upon departure from conditioner 203, are calculated.
3) Each Slice's content is moved 1 slice closer towards the conditioner outlet.
4) Maximum, minimum and average future temperatures are calculated and used as input to a PID controlling steam regulation.

The conditioner controller 223 also regulates the steam in the system. When two-thirds of the conditioner is in a loaded state, steam will be enabled. When fully loaded, steam PID will be enabled.

There are 2 PID's in the conditioner controller 223.
1) Steam Regulation PID—directly controls the steam regulation valve.
2) Estimator PID—regulates the mathematical constants used for estimator operation.

### Pelleter Controller

The primary job of the pelleter controller 225 is to feed the FeedRatePerMotorAmp variable back up to the feeder controller 221. This is calculated by taking the estimated feed rate from the conditioner 203 and dividing the motor amps. Before being fed up to the feeder controller 221, this value goes through an averaging filter.

The pelleter 205 also passes along the feed rate to the cooler 206 for cooler integration and checks.

Motor over amperage conditions are monitored for and signaled to the feeder for feed rate compensation.

In the event a motor stops running, or extreme, 150% overcurrent for extended period of 10 seconds the conditioner, steam and feeder will be immediately stopped.

### Corrective Action:

1) If motor is running, restart system after cleaning error.
2) If motor failed, resort to idle/error state. Manual intervention required.

### Cooler Controller

The cooler controller 226 controls blower, airlock, separator and cooler discharge. On system shutdown, the cyclone will enter clean out mode, where the airlock continues to run, but the blower is turned off.

If the cooler controller 226 detects that the material in motion, conditioner material, pellet material and cooler material, exceeds capacity or if there is a cooler 206, blower, and airlock 207 failure, the feeder will be placed into HOLD status.

Based on material in motion and level of grain in the cooler, it regulates cooler discharge to maximize cooling of pellets, and maintains an estimate of material in the cooler 206, and material that has passes through the cooler 206.

### System Overview

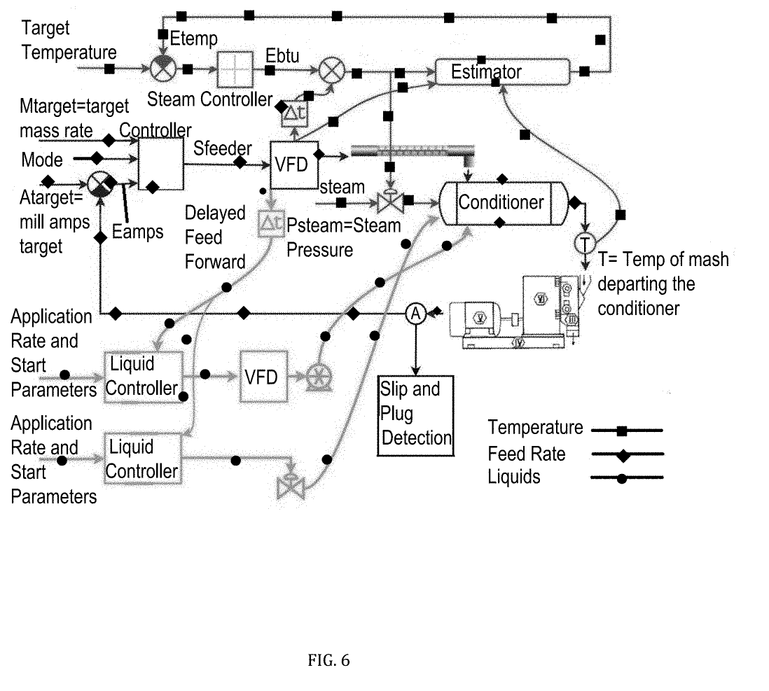

As illustrated in FIG. 6 the system from the feeder through to pelleter discharge composes of 3 integrated control systems depicted in the above control loop diagram. On the left-hand side of the diagram are the operating parameters controlling the loop behaviors.

The first control system is the mash product flow loop which is limited by the lesser of the RATE mode or MOTOR lode. The system will ramp up product flow rate at programmable fixed rate. in the event of motor overloads, the RATE will be decreased for the duration of the over load. In MOTOR LOAD mode, the percent of rated motor amps is the target, i.e. 95% motor load, of the PID loop.

The second control system is the thermal steam regulation loop. If uses either an estimated or actual temperature output of the conditioner to regulate the steam valve and maintain desired temperature output. An estimator is provided to increased loop response time. The estimator monitors the actual temperature output and the predicted and adjusts its calibration in an ongoing fashion.

The third control system regulates operational liquids for injection into the conditioner. Each liquid gets and application rate, starting condition includes temperature, material flow rate and additional delayed start. Liquid application rates, lbs/ton, are given and the actual pump speeds will change when the feeder rate changes.

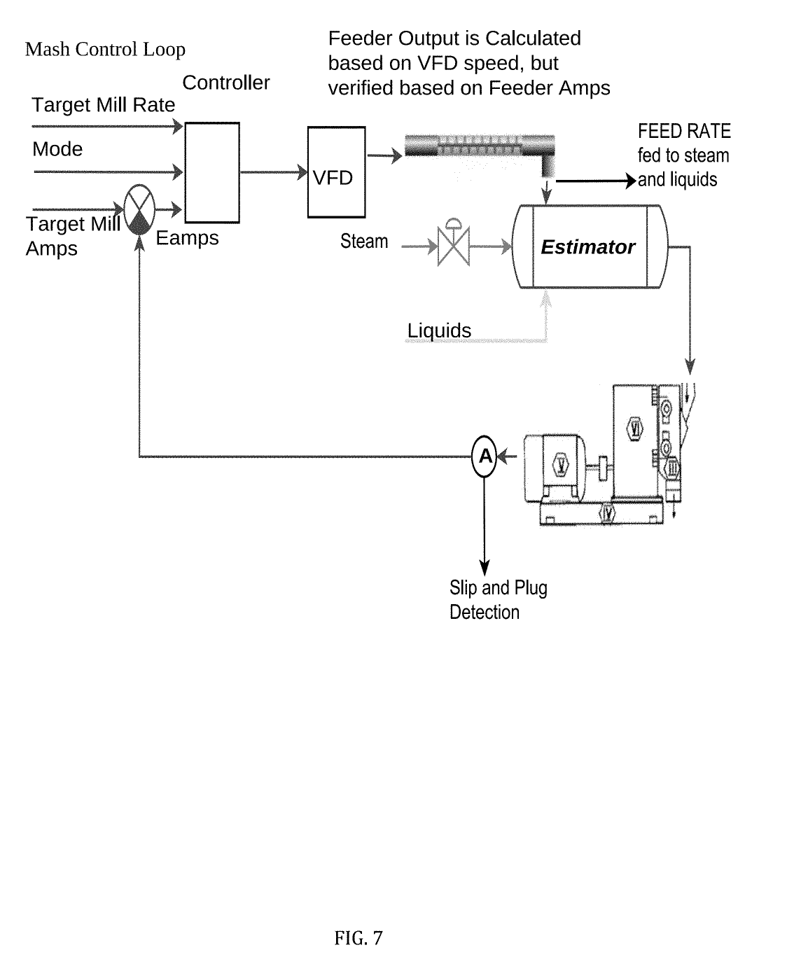

The first control system, the mash control loop, is shown separately in the diagram of FIG. 7.

The Controller implements both a RAMP and PID controller. In RAMP mode, pellet mill over ramp conditions cause immediate back off of the ramp. The controller drives the feeder VFD which turns feeder at variable speeds to control the feed rate of material into the conditions. Feeder Amps and Power factor are monitored and used to detect out of product conditions and verify product is being delivered.

When the feeder has detected product flow, it will provide the mash flow rate to the temperature and liquid controls, allowing them to have immediate response to throughput changes. The feeder will also totalize the flow of materials through it to provide a running display of tons pelleted, and tons remaining for targeted orders.

The conditioner estimator also models the flow of material through the conditioner and after the program transit time, provides the pellet mill an estimate of the material delivery rate, temperature and moisture content.

The pellet mill motor amps are monitored for sudden unexpected changes to motor amps as well as over-amp conditions. Motor overamps will initiate a lowering of feeder rates. Sudden, unexpected, changes in motor current will initiate anti-plug and anti-roll recovery procedures.

Using the estimator discharge rate and mill amps, a value is derived of amps vs tons/hour. This value is also used for rate correction and to limit the rate to no more than that which would be product maximum amps.

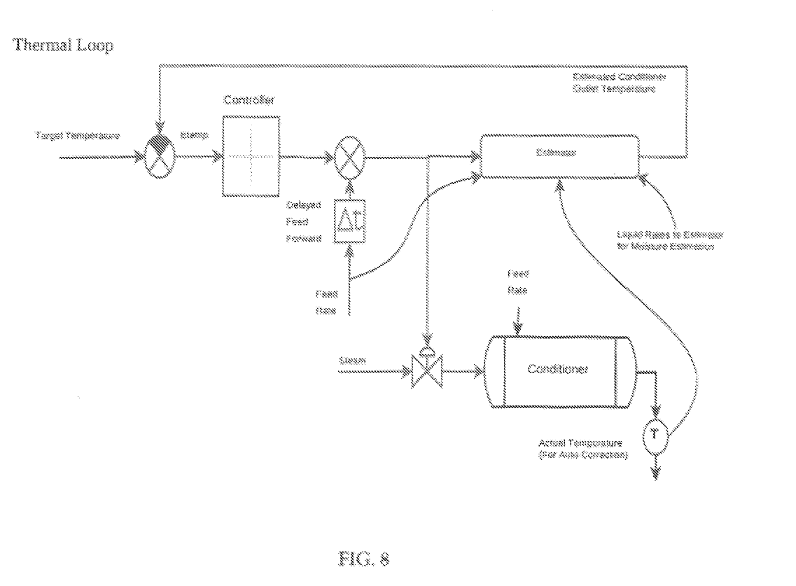

The second control system, the thermal loop, is shown separately in the diagram of FIG. 8.

The thermal control loop implements 2 modes:

1) Estimator Mode which utilize the estimator to provide the maximum, minimum and current predicted mash discharge temperatures. This provides for much faster response to system changes. The feed forward of the feed rate changes is accounted for inside the estimator.

2) Actual Mode which utilizes actual, vice estimated, conditioner discharge temperature. As the estimator output is not used, the feed forward should be implemented. Delay for the feed forward should be approximately one-half the conditioner transit time.

The estimator will run regardless of mode. When running in manual or Actual mode, only the auto-corrector inside the estimator will be actually be running.

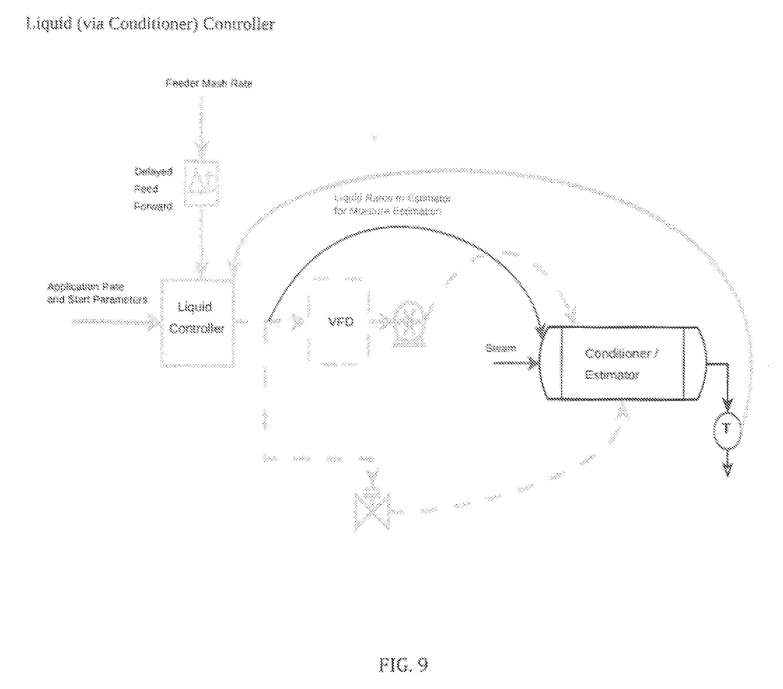

The third control system, the liquid controller, is shown in the diagram of FIG. 9.

Multiple configurations of liquids may be added to the conditioner. The liquid controller implements a simple open loop controller and may drive either regulator valve or a variable speed pump. Liquids may be measured by either volumetric or mass flow systems. In the absence of a measuring device, liquids will be quasi-measured based on command speed vs maximum speed.

The liquid controller is fed mash throughout and corrects liquid delivery rate to match mash flow. Liquid start point can be based on conditioner output temperature, mush throughput, percentage of target flow rate, or any combination of the 3 parameters. Additionally, the controller supports a timed delay as well, i.e. Start 20 seconds AFTER the conditioner outlet temperature has reached 180 degrees AND throughput is at least 50% of target flow rate.

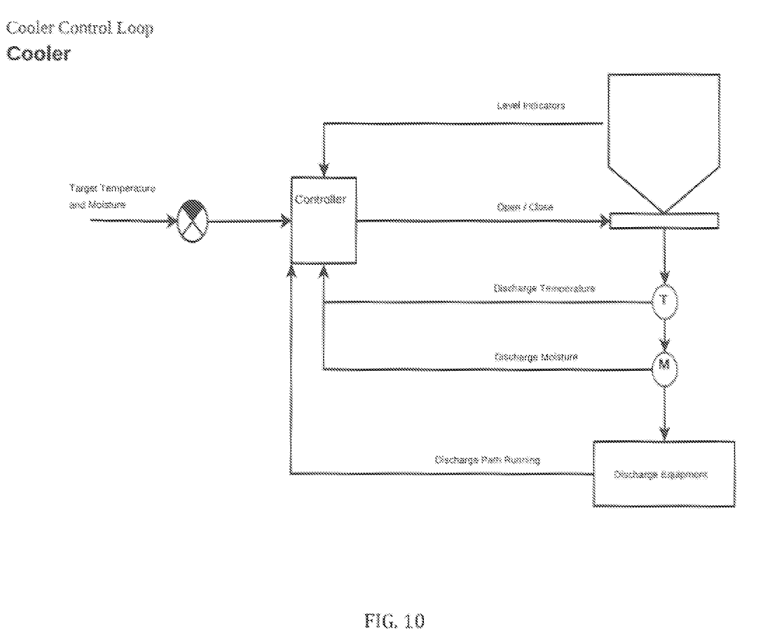

A additional control system, the cooler control loop, show in the diagram of FIG. 10, may also be used.

Cooler control operates in either a Maximum cooling mode or Targeted Mode. Targeted mode set points can be either moisture, temperature or a combination of both. The opening/closing of the cooler discharge gate is controlled via a slow speed pulse width modulation. The open vs closed times are determined by the PWM output.

Sensors for Low, High, and High-High are provided. The system increases the open time of the PWM when the cooler has a high level. High-High level initiates an error condition, causing the Pellet Mill to decrease the feed rate.

The High-High sensor should be placed at a point where the cooler still has room to hold all material in the conditioner and pellet mill.

The following EXAMPLES use a pellet mill with the following characteristics:
Die Motor: 200 Horse Power
Screw Feeder: 12 Ton/Hour at 60 Hz motor speed
Conditioner Dwell Time: 20 Seconds
Mash Characteristics: 35 lbs/ft3 median density 0.35-0.5

$$\frac{BTU}{lb dT}$$

specific heat
Steam Source: 85 PSI pressure regulated saturated steam (−1180 BTU/lb) 2 ton/hour boiler plant

### System Safety Programming

Automatic Liquid Shutoff—when feeder goes empty (sensed by feeder amps) or pellet mill goes empty (sensed by die motor amps.)
Automatic Steam Shutoff when—when pellet mill die and feeders are empty
Plug Prevention—automatic shutoff of die feeders upon pellet mill over-amp conditioner

Also, the following Examples use a controller having:

### Formula Specific Settings:

Cp=specific heat of mash
Dmash=density of mash
Ttarget=target mash temperature departing the conditioner
Mtarget=mass rate target of mash entering the pellet mill
Atarget=target pellet mill amps
Ltarget=target liquid application rate (in lbs of liquid/ton of mash)
Lminrate=minimum mash rate for application of liquids

### System Parameters/Variables:

Steam valve characterization (quadratic)
Steam Loop Cycle Time (time from steam valve position change to observation of temperature change)
System Steam Pressure (via pressure transducer or static setting)
Liquid valve characterization (quadratic)
Feeder screw characterization (dual value linear with offset)
Steam Boost threshold
Steam Boost amount
Required temperature for ramping
Target ramp time (used to determine aggressiveness of feeder ramping)
Feeder loop cycle time (time from a rate increase of the feeder to the time the change in mill amps is seen)

### System Parameters/Variables:

Steam valve characterization (quadratic)
Steam Loop Cycle Time (time from steam valve position change to observation of temperature change)
System Steam Pressure (via pressure transducer or static setting)
Liquid valve characterization (quadratic)
Feeder screw characterization (dual value linear with offset)
Steam Boost threshold
Steam Boost amount
Required temperature for ramping
Target rap time (used to determine aggressiveness of feeder ramping)
Feeder loop cycle time (time from a rate increase of the feeder to the time the change in mill amps is seen)

### Monitor Points

Aactual—actual amps drawn by pellet mill
Tmash_out—temperature of mash departing the conditioner
Psteam—pressure of steam (if equipped with a pressure transducer)
Afeeder—feeder amps (monitored to determine when empty)

### System Approximation Points

Tmash_in—assumed to be ambient temperature
Psteam—if not equipped with pressure transducer

### EXAMPLE 1

### Estimator Operation

Given a reasonably accurate calculation of BTU/sec being delivered through the steam valve, the volumetric mash rate, incoming mash temperature, mash density and conditioner dwell time, one can reasonably estimate the expected temperature departing the conditioner at a given time.

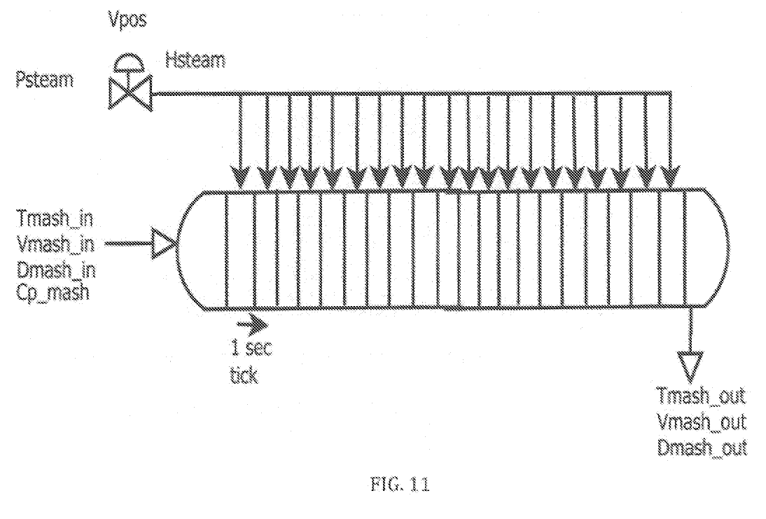

Reference to FIG. 11, if one envisions the conditioner dwell time as a series of slots. Each second, the contents of each slot is shifted to the right. At the end of dwell time, the contents of the last slot are discharged from the conditioner. We an assume an even distribution of steam in the conditioner.

Given the equation for Specific heat

$${C}_{p} = \frac{H}{dTm} \text{?} , \\ \text{?} \text{indicates text missing or illegible when filed}$$

we can determine conditioner output temperature as:

$${T}_{mash\_out} = {T}_{mash\_in} + \frac{\frac{\text{?} BTU ( {V}_{pos} ( t ) , {P}_{steam} ( t ) )}{{t}_{dwell}}}{{C}_{p} {R}_{mash} {D}_{mash}}$$

$$\text{?} \text{indicates text missing or illegible when filed}$$

We can also correct for errors in Cₚ by readjusting Cₚ to the calculated value determined by:

$${C}_{p} = \frac{\text{?} \frac{BTU ( {V}_{pos} ( t ) , {P}_{mash} ( t ) )}{{t}_{dwell}}}{( {T}_{mash\_out} - {T}_{mash\_in} ) {R}_{mash} {D}_{mash}}$$

$$\text{?} \text{indicates text missing or illegible when filed}$$

The error between formula specific heat (Cₚ_{_}_{formula}) and the current calculated Cₚ_{_}_{observed}, is fed into a proportional control loop to correct for disturbances between Cₚ_{_}_{formula} and Cₚ_{_}_{observed}. At the end of a pellet run, the Cₚ_{_}_{observed} will then be used to update the system data tables to have a better starting point when the same formula is ran again. The result of this control loop is Cₚ_{_}_{current} which is used by the system as the current specific heat.

BTU (vₚₒₛ)(t), Pₛₜₑₐₘ(t)) is used to determine the heat energy flow into the conditioner. This will generally be determined by either a linear or quadratic equation based on valve flow characteristics. The valve characteristics are statistically determined by observation of several mash runs at differing mass rate and target temperatures.

As a (rough) starting point, we an estimate a valve's full open heat capacity using m=1.61 C, P_{Steam}² to determine steam lbs/hour and approximating the steam heat capacity per pound as 1180 BTU/lb³ (enthalpy of saturated steam).

This gives a BTU/second as approximately Hₛₜₑₐₘ=0.528×Vₚₒₛ×Cᵥ×Pₛₜₑₐₘ.

### EXAMPLE 2

### Thermal Loop Operations

The steam control loop utilizes two modes of operation:

Closed Loop—Normal operating mode, closed loop operation. Steam valve position adjustments are made by calculating the heat requirements needed to affect the desired temperature change, for the current mass flow rate and specific heat of mash. The thermal errors are processed by a PID function. An inverse of the BTU function is used to derive the new position based on updated target heat energy flows. The PID function runs at a clock rate equal to the conditioner loop time.

### CLOSED LOOP EXAMPLE 2A

If the steam valve is a linear 7.9 Cv valve with a constant 90 PSIA, then the linear coefficient would be 374. If we are in Closed Loop mode with the following parameters:

| Parameter | Value | All steps (except 4) are processed continuously | |
|---|---|---|---|
| T [symbol] | 70° F. | 1) | Calculate current mass rate |
| T [symbol] | 145° F. | | V [symbol] = Feeder Speed × Vol/Hz = 0.127 ft [symbol] |
| Feeder Vol/Hz | 0.00353 ft³ | | M [symbol] = V [symbol] D [symbol] = 4.44 lbs/s (6 Ton/hour) |
| M [symbol] | 4.40 lbs/s | 2) | Calculate temperature errors |
| P [symbol] | 90 PSIA | | E [symbol] = T [symbol] − T [symbol] = 60° F. |
| K [symbol] | 0.25 | 3) | Calculate current heat appication rate |
| K [symbol] | 0 | | H [symbol] = BTU(V [symbol] , P [symbol] ) = 130 BTU/s |
| K [symbol] | 0 | 4) | Perform PID function on BTU rate error |
| Valve Quadatic Coefficient | 0 BTU/s | | *** Calculated ONCE per steam loop period *** |
| Valve Linear Coefficient | 374 BTU/s | | ${H}_{error} = C \text{?} M \text{?} E \text{?} = 0.45 \frac{BTU}{lb \times dT} \times 444 lbs \text{/} s \times 60 ° F . = 120 BTU \text{/} s$ |
| Valve Offset | 0 BTU/s | | ${H}_{adjusted} = H \text{?} + PID ( H \text{?} ) = 130 BTU \text{/} s + 30 BTU \text{/} s = 160 BTU \text{/} s$ |
| D [symbol] | 35 lbs/ft [symbol] | 5) | Calculate and add in the mass rate feed forward values |
| C [symbol] C [symbol] | 0.45 BTU/lb×dT | | M [symbol] = M [symbol] - M [symbol] |
| | | | H [symbol] = H [symbol] + C [symbol] M [symbol] T [symbol] |
| Current Conditions | | 6) | Calculate new valve position |
| V [symbol] T [symbol] Feeder Speed | 35% (0.35) 130° F. 36 Hz. | | $\begin{matrix}V \text{?} = BTU \text{?} ( {H}_{adjusted} , P \text{?} ) = BTU \text{?} ( 160 BTU \text{/} s , 90 ) = \\ 0.428 = 42.8 \% open\end{matrix}$ |
| | | 7) | Compare C to C, make proportional |
| | | corrections to C | |
| | | | $C \text{?} = K \text{?} C \text{?} \frac{T \text{?}}{T \text{?}}$ |

[symbol]

indicates data missing or illegible when filed

Open Loop—During this warm-up phase operation, the system operates as an open loop system, utilizing mash feed rate (lbs/sec), density and specific heat, along with the required temperature rise to calculate the heat requirements for the mash. The steam valve is determined by the heat requirements and steam valve characterization. When conditioner outlet temperature is below a system programmable threshold, a configurable amount of “boost” steam may be applied to accelerate temperature rise. When within a configurable threshold, the system switches to Warm Loop mode.

### OPEN LOOP EXAMPLE 2B

Same system parameters and configuration.

| Parameter | Value | Process per Tick | |
|---|---|---|---|
| T [symbol] | 70° F. | 1) | Calculate current mass rate |
| T [symbol] | 145° F. | | V [symbol] = Feeder Speed × Vol/Hz = 0.127 ft [symbol] |
| Feeder Vol/Hz | 0.00353 ft³ | | M [symbol] = V [symbol] D [symbol] = 4.44 lbs/s (6 Ton/hour) |
| M [symbol] | 4.40 lbs/s | 2) | Calculate heat method for current mass rate, specific heat and |
| P [symbol] | 90 PSIA | | requested temperature rise. |
| K [symbol] K [symbol] K [symbol] | 0.25 0 0 | | $\begin{matrix}H \text{?} = C \text{?} \text{?} ( T \text{?} - T \text{?} ) = 0.45 \frac{BTU}{lb \times dT} \times 444 lbs \text{/} s \times \\ ( 145 ° F . - 70 ° F . ) = 150 BTU \text{/} s\end{matrix}$ |
| Valve Quadratic | 0 BTU/s | 3) | Determine if additional stream boost is needed (temperature |
| Coefficient | | error is greater than configured threshold) | |
| Valve Linear | 374 BTU/s | | H [symbol] = H [symbol] + H [symbol] [symbol] (T [symbol] ⇐ [T [symbol] - T [symbol] ]) = |
| Coefficient | | | 150 BTU/s - 30 BTU/s [symbol] (130° F. ⇐ [145° F. - 15° F.]) |
| Valve Offset | 0 BTU/s | 3) | Calculate new valve position |
| D [symbol] | 35 lbs/ft [symbol] | | $\begin{matrix}V \text{?} = BTU \text{?} ( H \text{?} P \text{?} ) = BTU \text{?} ( 160 BTU \text{/} s , 90 ) \text{?} = \\ 0.482 = 48.2 \% open\end{matrix}$ |
| C [symbol] | 0.45BTUlb×dT | 4) | Compare C [symbol] to C [symbol] , make proportional |
| C [symbol] | | corrections to C [symbol] . | |
| H [symbol] | 30 BTU/s | | $C \text{?} = K \text{?} C \text{?} \frac{T \text{?}}{T \text{?}}$ |

| T [symbol] | 15° F. |
|---|---|
| Current Conditions | |
| V [symbol] | 35% (0.35) |
| T [symbol] | 130° F. |
| Feeder Speed | 36 Hz. |

[symbol]

indicates data missing or illegible when filed

### EXAMPLE 3

### Feed Rate Controller

Typically, feed rate ramping is done in a linear fashion. This is adequate for fast responding systems where the effect on the change of feed rate is near immediate. In the pellet mill system, the effectes of the feed rate changes can take up to a minute for the full effect to be seen in the way of amps draen by the pellet mill. This presents a problem when nearing the target mill amps setpoint, as we will most likely overshoot out target if operating on a linear time ramping scale.

A common solution to prevent this is to have 2 ramping values, a fast ramp and a slow ramp, where the determination of ramp speed is determined by how off the amps are from the target ramps.

A better solution is to approach the target from the curved approach. The closer we get to the target rate, the slower the ramp runs. This is implemented using the following approach.

1) Calculate the linear ramp rate, based on target on target time for the ramp.

$${R}_{ramp} - \frac{{R}_{target} - {R}_{start}}{{T}_{ramp}}$$

2) Calculate the percent error on amps

Eₐₘₚₛ=A_{target}−A_{actual}

3) Utilize the error to decrease the ramp rate as we get closer to target amps.

$${R}_{feeder} = {R}_{feeder} + {R}_{ramp} Max ( \begin{matrix}{E}_{amps}^{3} \\ {E}_{threshold}^{2}\end{matrix} , 1 )$$

The HIGH-HIGH sensor should be placed at a point where the cooler still has room to hold all material in the conditioner and pellet mill.

Although only an exemplary embodiment of the invention has been described in the detail above, those skilled in the art will readily appreciate that many modifications are possible without materially departing from the novel teachings and advantages of this invention. Accordingly, all such modifications are intended to be included within the scope of this invention as defined in the following claims.

1. A controller for a pellet mill having a feeder, a conditioner, a pelleter and a cooler, the controller compromising:
a feeder controller;
a conditioner controller; and
an estimator operably connected to the feeder controller and conditioner controller, to monitor conditioner input variables of steam, material density, and feed rates and estimate material departure temperature density and moisture content.

2. The controller of claim 1, further including a pelleter controller; and
wherein the estimator is operably connected to the pelleter controller.

3. The controller of the claim 1, further including a cooler controller; and
wherein the estimator is operably connected to the cooler controller.

4. The controller of claim 2, further including a cooler controller; and
wherein the estimator is operably connected to the cooler controller.

5. A method of controlling input variables of a pellet mill using the controller of claim 1, the method comprising the steps of:
determining a current mass feed rate;
determining temperature errors;
determining a current steam application rate;
performing a PID function on a BTU rate error;
determining and adding mass rate feed forward values;
determining a new steam valve position; and
comparing an observed specific heat of mash and an estimated specific heat of mash, and making proportional corrections to the current specific heat of mash.

6. The method of claim 5, further including the steps of:
determining when the pellet mill is in a warm up phase and thereafter;
determining a current mass feed rate;
determining a needed steam application rate for current mass feed rate,
a current specific heat, and a target temperature;
determining if additional steam is needed;
determining a new steam valve position; and
comparing an observed specific heat of mash and an estimated specific heat of mash, and
making proportional corrections to the current specific heat of mass.

7. The method of claim 5, further including the steps of:
determining a linear ramp feed rate based on a target time for a ramp;
determining a percent amps error based on target amps drawn and actual amps drawn; and
decreasing the ramp feed rate based on the amp error as the target amps drawn is approached.
